(19) United States
(12) Patent Application Publication
(10) Pub. No.: US 2023/0093688 A1
(43) Pub. Date: Mar. 23, 2023

(54) METHOD AND SYSTEM FOR PROVIDING INCENTIVES FOR VIEWERS TO WATCH ADVERTISEMENTS

(71) Applicant: Dana Suess, Tucson, AZ (US)

(72) Inventor: Dana Suess, Tucson, AZ (US)

(21) Appl. No.: 17/994,093

(22) Filed: Nov. 25, 2022

Related U.S. Application Data
(60) Provisional application No. 63/283,530, filed on Nov. 29, 2021.

(51) Int. Cl. G06Q 30/0207; H04N 21/475; H04N 21/4784; G06Q 30/0251; G06Q 30/0242

(52) U.S. Cl. CPC G06Q 30/0236; H04N 21/4755; H04N 21/4784; G06Q 30/0257; G06Q 30/0245

(57) ABSTRACT

Presented is a method and system for providing an incentive to a viewer for watching an advertisement. The method includes receiving a triggering event from the viewer, providing an interactive window on receiving the triggering event, receiving an input from the viewer while interacting with the interactive window, performing an action based on the input from the viewer, wherein the action includes presenting the selected advertisement to the viewer if the input is selecting at least one advertisement from the advertisement group, and capturing advertisement preferences of the viewer through a user interface if the input is clicking a user interface element related to advertisement preferences from the one or more user interface elements. Further, the method includes providing an incentive to the viewer, and facilitating the viewer's redemption of the incentive for rewards.

### CROSS-REFERENCE TO RELATED APPLICATIONS

This application claims priority to U.S. Provisional Application No. 63/283,530 filed on Nov. 29, 2021 and titled “Better Advertising model for the internet”. The content of the above application is incorporated by reference in its entirety.

### TECHNICAL FIELD

The present invention relates generally to advertising management on content delivery systems, and more particularly, to a method and system for providing incentives for viewers to watch advertisements.

### BACKGROUND

In the past decade, there has been significant growth in various in-home entertainment options, including but not limited to broadcast TV, on-demand programming, online gaming, and online video. Much of this growth has been driven by cable and satellite television and Internet, which not only provides more entertainment content than traditional methods of providing content such as over-the-air broadcast television but also provides the ability to view programming on demand As a result, viewer is getting more options to watch entertainment content. To take advantage of this kind of environment, there is a desire in the media and entertainment industry to attract viewers. There is also an associated desire in the media and entertainment industry to retain viewers. Eventually, it provides a chance for advertisers to broadcast advertisements along with entertainment content.

The world runs on an antiquated advertising model from the early days of television when ads were inserted into the content. It's a miserable way to watch a movie and a poor way to shop due to synchronous nature of television technology. Further, in the Internet era, no one took advantage of the Internet's asynchronous nature to create a better ad experience. The most annoying aspect of using the internet is pop-up ads timing. The viewers watching an entertainment video don't want to be suddenly forced to watch the advertisement. It is jarring. Further, the viewers also don't like pop-up ads when surfing the web. These pop-up ads are causing distractions. The ads are often off-target because ad brokers can only guess what a viewer wants. Some ads force the viewer to watch them until the end which is an abusive way to interface with prospects. Many viewers have become blind to pop-up ads. When watching any entertainment content, the viewer waits for a few seconds to click the “Skip Ads” button and get back to watching what they were watching before being interrupted by that advertisement.

Further, to avoid advertisement, the viewers must purchase an adblocker or ad filtering software to get rid of pop-up ads. Otherwise, they must pay to the content provider for displaying no ads while watching the entertainment content. The popularity of ad-blockers confirms the current internet advertising model is dysfunctional. As a result, viewer's experience with the advertisement is poor and the click-through-rate of the advertisement is not good.

To address the scenario discussed above, U.S. Pat. No. 8,005,713B1 discloses a method and system which provides interactive advertising with an automated viewing reward system. The user controls various aspects of the advertising and earns value in return for agreeing to or allowing certain advertising actions. The user pays a subscription fee for the streaming content. The user also has the power to determine which advertisements (or blocks of advertisements) that the user wishes to view. For example, the user may have a remote control with a “skip advertisement” button. Each advertisement has a value associated with it, and by viewing that advertisement, the user earns credits against the user's subscription fee.

Currently, none of the existing systems and methods can provide an improved internet advertising model that eliminates the need for pop-up ads, off-target ads, and disruptive ads in general while increasing ad clicks. Further, none of the existing systems and methods can facilitate the viewers to watch the ads at their convenience, earning a token for each minute they view ads and redeeming those tokens for watching ad-free entertainment content.

Although advertisement methods and systems are proposed in the past, they have their own shortcomings or limitations, thus there still exists a need for a more reliable solution that can provide an improved internet advertising model that eliminates the need for pop-up ads, off-target ads, and disruptive ads in general while increasing ad clicks. Accordingly, the inventor herein proposes a method and system for providing an incentive to the viewer for watching an advertisement.

### SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

It is an objective of the present invention to provide a method and system for rewarding an incentive to a viewer for watching an advertisement.

It is another objective of the present invention to provide an improved internet advertising model that eliminates the requirement for pop-up ads, off-target ads, and disruptive ads in general while increasing click-through-rate for the advertisements.

In an embodiment, the present invention provides a system and method for providing an incentive to a viewer for watching an advertisement. The method includes receiving a triggering event from the viewer, wherein the triggering event occurs when the viewer actuates a web element. Further, the method includes providing an interactive window on receiving the triggering event, wherein the interactive window comprises one or more user interface elements, and a section for displaying an advertisement group to the viewer, wherein the advertisement group comprises at least one advertisement. Further, the method includes receiving an input from the viewer while interacting with the interactive window, wherein the input comprises at least one of selecting one or more advertisements from the advertisement group, clicking a user interface element from one or more user interface elements, and entering preference for the advertisement in an input text box of the one or more user interface elements. Further, the method includes performing an action based on the input from the viewer, wherein the action includes presenting the selected advertisement to the viewer if the input is selecting at least one advertisement from the advertisement group, capturing advertisement preferences of the viewer through a user interface if the input is clicking a user interface element related to advertisement preferences from the one or more user interface elements, and presenting the one or more advertisement related to the entry into the input text box if the input is entering preference for the advertisement in the input text box of the one or more user interface elements. Further, the method includes providing an incentive to the viewer, wherein value of incentive prorated according to an amount of time the selected one or more advertisements watched by the viewer. Further, the method includes facilitating the viewer's redemption of the incentive for rewards.

In an embodiment, means for actuating the web element comprises one of touching, clicking, and tapping.

In an embodiment, the web element comprises one of a widget, a click button, a graphical control element, and a graphical user interface element.

In an embodiment, the user interface elements comprise one of checkboxes, radio buttons, dropdown lists, list boxes, buttons, toggles, text fields, date field, icons, carousels, and search fields.

In an embodiment, the interactive window comprises of a dynamic flyer, a card, and a modal.

In an embodiment, displaying one or more advertisements in the interactive window on receiving the triggering event further includes determining whether the viewer's advertisement preferences are available, displaying random or default advertisements in the interactive window if it is determined that the viewer's advertisement preferences are not available, obtaining the viewer's advertisement preferences if it is determined that the viewer's advertisement preferences are available, matching the one or more advertisement to the viewer's advertisement preferences, and displaying the advertisements, related to the viewer's advertisement preferences, in the interactive window.

In an embodiment, the input further includes at least one of bookmarking one or more advertisements, fetching similar advertisements corresponding to the advertisement group, and exiting the interactive window.

In an embodiment, the incentive includes at least one of a loyalty point, a virtual coin, and a value token.

In an embodiment, the reward is selected from the group consisting of advertisement free time-duration for watching content, advertisement free time-duration for browsing, advertisement free premium content, and the like.

In an embodiment, the method further includes displaying a list of rewards for which the viewer may be eligible, receiving a reward selection by the viewer, and providing a reward to the viewer based on the reward selection.

In an embodiment, the method further includes allowing the viewer to perform accounting operations with the incentive available to the viewer, wherein accounting operations include checking, buying, and selling the incentives available to the viewer.

These and other features and advantages of the present invention will become apparent from the detailed description below, in light of the accompanying drawings.

### BRIEF DESCRIPTION OF THE DRAWINGS

FIG. 1 illustrates a computing environment or general implementation for providing an incentive to a viewer for watching an advertisement, according to an exemplary embodiment of the present invention;

FIG. 2 is a block diagram illustrating a preferred architecture for the content provider to provide the incentive to the viewer for watching the advertisement, according to an embodiment of the present invention;

FIG. 3 illustrates an example user interface for receiving a triggering event from the viewer, according to an embodiment of the present invention;

FIG. 4 illustrates an example user interface of an interactive window for receiving an input from the viewer, according to an embodiment of the present invention;

FIG. 5 illustrates an example user interface for capturing advertisement preferences of the viewer, according to an embodiment of the present invention;

FIG. 6 illustrates an example user interface for displaying a selected advertisement to the viewer, according to an embodiment of the present invention;

FIG. 7 illustrates an example user interface for presenting one or more advertisements related to an entry into the input text box displayed in FIG. 4, according to an embodiment of the present invention;

FIG. 8 illustrates an example user interface for displaying a list of rewards for which the viewer may be eligible, according to an embodiment of the present invention;

FIG. 9 illustrates an example user interface for redeeming the incentive for a reward, according to an embodiment of the present invention;

FIG. 10 illustrates a flow diagram of a method for providing the incentive to the viewer for watching the advertisement, according to an exemplary embodiment of the present invention;

FIG. 11 illustrates a flow diagram of a method for displaying advertisements in an interactive window on receiving the triggering event, according to an exemplary embodiment of the present invention; and

FIG. 12 illustrates a system for providing the incentive to the viewer for watching the advertisements, according to an exemplary embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a system and method for providing an incentive to a viewer for watching an advertisement. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items. Further, the word “user” and “person” are used interchangeably in the description.

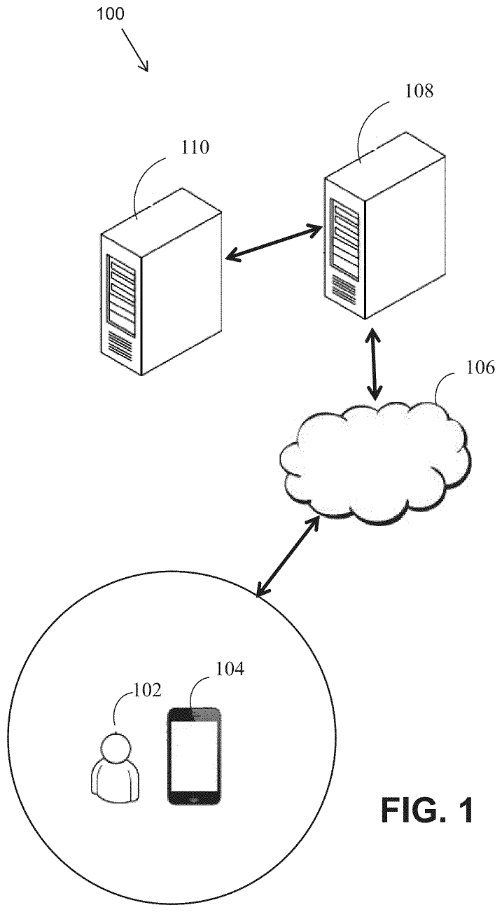

The system and method for providing an incentive to a viewer for watching an advertisement will now be described with reference to the accompanying drawings, particularly FIGS. 1-12.

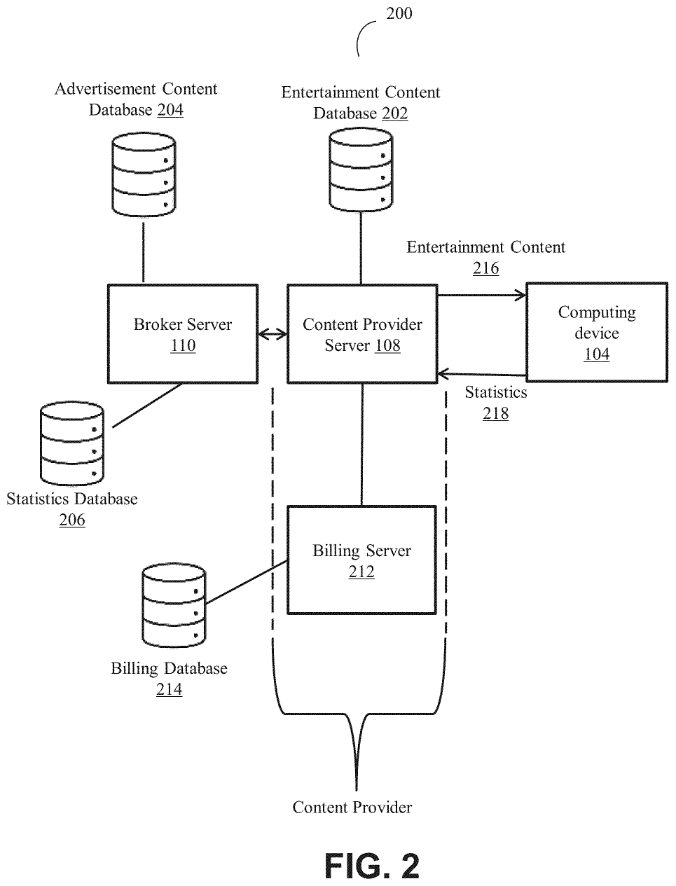

Referring to FIG. 1 in conjunction with FIGS. 2-12, a system 100 for providing the incentive to the viewer 102 for watching the advertisement is shown, in accordance with an exemplary embodiment of the present invention. The system 100 includes the viewer 102 who can watch a content, stored on a content provider server 108, through a computing device 104. Examples of the content include, but are not limited to a video, an audio, an on-demand multimedia, a web page, an online gaming content, and a television program. In an example, the content provider server 108 includes a content database that stores data related to the content. Further, the content provider server 108 is operationally coupled to a broker server 110. In an example, the broker server 110 includes an advertisement content database and a statistics database. The advertisement content database stores data related to advertisements. Examples of advertising include television commercials, commercial brand promotions, program previews and “teasers” or short segments to motivate the viewing of future commercials. Further, the statistics database stores data related to click-through-rate (herein after referred as CTR) of an advertisement, viewer's advertisement preference, data related to incentives, and the like. In an embodiment, the content provider server 108 and the broker server 110 are two different entities. In another embodiment, the broker server 110 is a part of the content provider server 108.

In an embodiment, the viewer 102 can access the content, stored on a content provider server 108, via a client application (for example, an Over-the-Top application) that is installed on the computing device 104. In another embodiment, the content can be accessed through a web browser that is installed on the computing device 104. In an embodiment, the content provider server 108 is a cloud server and the client application is a cloud-based application.

In an example scenario, the viewer 102 is a new user of the client application or the content provider server 108. In that scenario, the content provider server 108 provides a sign-up option to the viewer 102 to create a profile with the content provider server 108. Through the sign-up option, the viewer 102 creates an account on the content provider server 108 by providing information such as First name, last name, date of birth, email ID, and the like. After receiving the sign-up information from the viewer 102, the content provider server 108 creates login credential for the viewer 102 and shares the login credential with the viewer 102 for subsequent login. The content provider server 108 receives the login credentials from the viewer 102 and provides access to a profile of the viewer 102 in the content provider server 108 based on the login credentials.

In context of the present invention, the computing device 104 refers to an electronic device that can be used to communicate over the communication network 106. Examples of the computing device 104 include, but are not limited to a cell phone, a smart phone, a cellular phone, a cellular mobile phone, a personal digital assistant (PDA), a personal computer, a server, a cloud enabled devices, a laptop, a smart television, and a tablet computer. Examples of types of the communication network 106 include, but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not be limited to a global system for mobile communication (GSM) network, a general packet radio service (GPRS) network, third Generation Partnership Project (3GPP), 4G, Long-Term Evolution (LTE), an enhanced data GSM environment (EDGE) and a Universal Mobile Telecommunications System (UMTS).

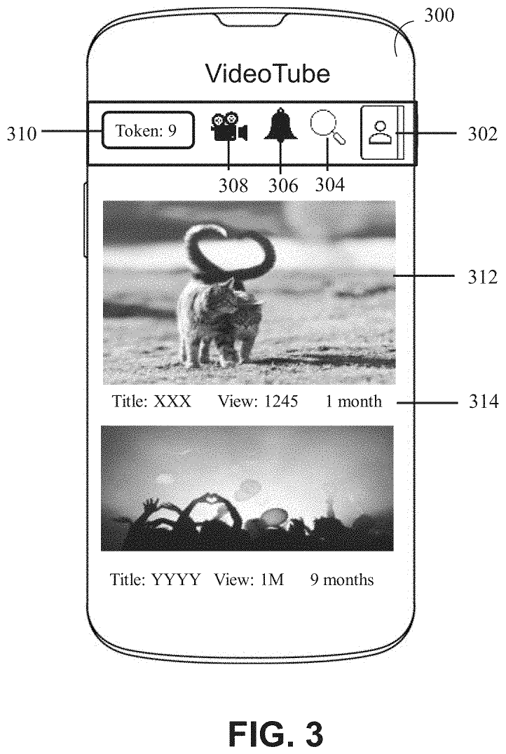

In an example scenario, the viewer 102 opens a multimedia application, installed on the communication device 104, to watch a video. The multimedia application receives contents that are broadcasted from the content provider server 108. When the viewer 102 opens the multimedia application, the user interface of the multimedia application provides a web element which can be actuates by the viewer 102. The user interface of the multimedia application is described in conjunction with FIG. 3. In an embodiment, the web element includes one of a widget, a click button, a graphical control element, and a graphical user interface element. When the viewer 102 actuates the web element, for example, tapping a click button, the content provider server 108 receives a triggering event related to the web element. In an embodiment, the viewer 102 performs one of touching, clicking, and tapping activity with the web element to actuates the web element.

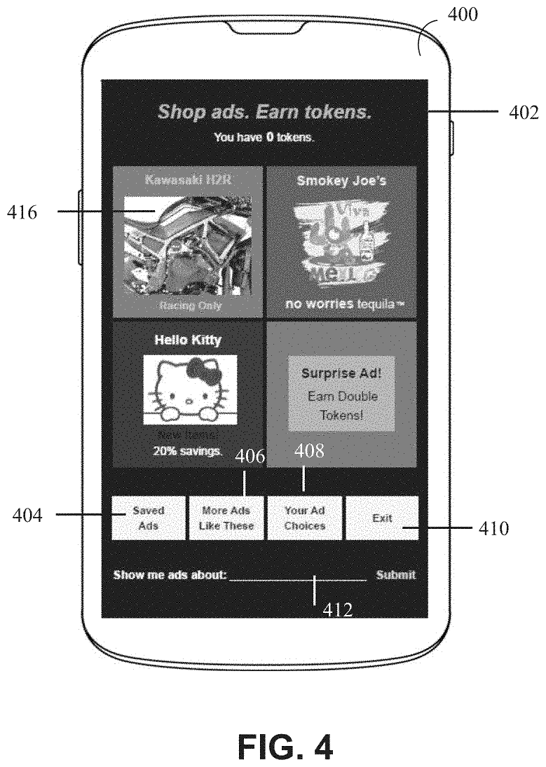

In an embodiment, on receiving the triggering event, the content provider server 108 determines whether the viewer 102 has actuated the web element for the first time, and provides an interactive window, as shown in FIG. 4, if it is determined that the viewer has actuated the web element for the first time, wherein the interactive window includes one or more user interface elements, and a section for displaying an advertisement group to the viewer, wherein the advertisement group includes random advertisements. In an embodiment, the interactive window includes one of a dynamic flyer, a card, and a modal. In an embodiment, the user interface element may be one of a checkbox, a radio button, a dropdown list, a list box, a button, a toggle, a text field, an icon, a carousel, and a search field.

Further, the content provider server 108 receives an input from the viewer 102 when the viewer 102 interacts with the interactive window. In an example, the input includes at least one of selecting one or more advertisement from the advertisement group, clicking a user interface element from the one or more user interface elements, and entering preference for the advertisement in an input text box of the one or more user interface elements. In an embodiment, the input further includes at least one of bookmarking one or more advertisement, fetching similar advertisements corresponding to the advertisement group, and exiting the interactive window. This input information is shared with the broker server 110.

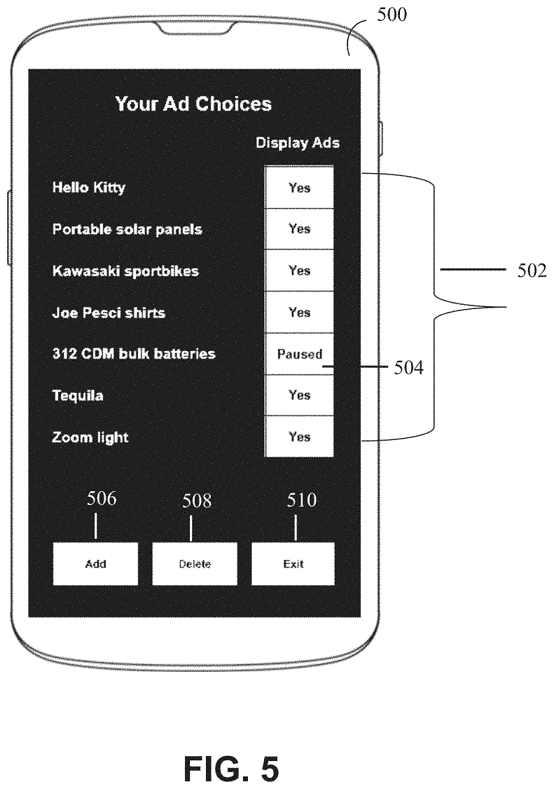

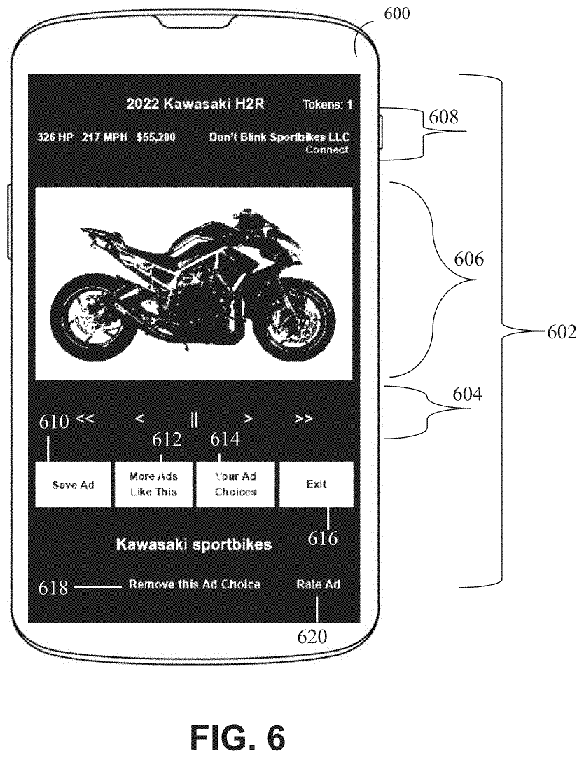

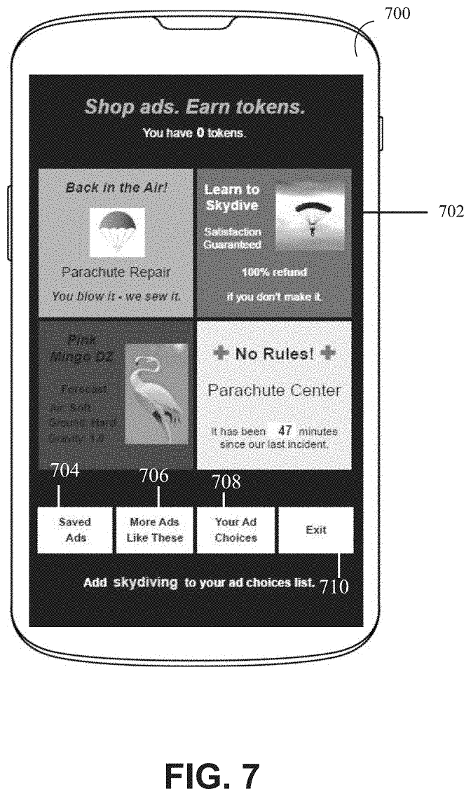

In an embodiment, the content provider server 108 is configured to perform an action based on the input from the viewer 102. In an example, the action includes presenting the selected advertisement to the viewer 102 if the viewer's input is selecting at least one advertisement from the advertisement group. An example user interface for displaying the selected advertisement to the viewer 102 is described in conjunction with FIG. 6. In another example, the action includes capturing advertisement preferences of the viewer 102 through a user interface if the viewer's input is clicking a user interface element related to advertisement preferences from the one or more user interface elements. The user interface for capturing advertisement preferences of the viewer 102 is described in conjunction with FIG. 5. In yet another example, presenting the one or more advertisement related to the entry into the input text box if the viewer's input is entering preference for the advertisement in the input text box of the one or more user interface elements. An example user interface for presenting one or more advertisement related to an entry into the input text box displayed in FIG. 4 is described in conjunction with FIG. 7.

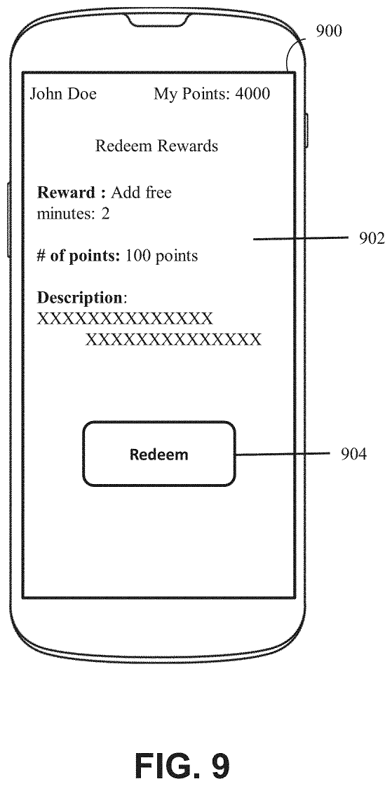

When the viewer 102 watches one or more advertisements along with the video, the content provider server 108 is configured to provide the incentive to the viewer 102. In an embodiment, the incentives may be at least one of a loyalty point, a virtual coin, and a value token. In an embodiment, a value of the incentive prorated according to an amount of time the selected one or more advertisements watched by the viewer 102. For example, if the viewer watches one advertisement, he/she can earn 1 token. In another example, a non-video (static) advertisement might allow a maximum of 15 seconds worth of viewing/tokens. In an example, the non-video advertisement is an image. Further, the content provider server 108 is configured to facilitates the viewer's redemption of the incentive for rewards. In an embodiment, the reward is selected from the group consisting of advertisement free time-duration for watching content, advertisement free time-duration for browsing, advertisement free premium content, and the like. An example user interface for redeeming the incentive for a reward is described in conjunction with FIG. 9.

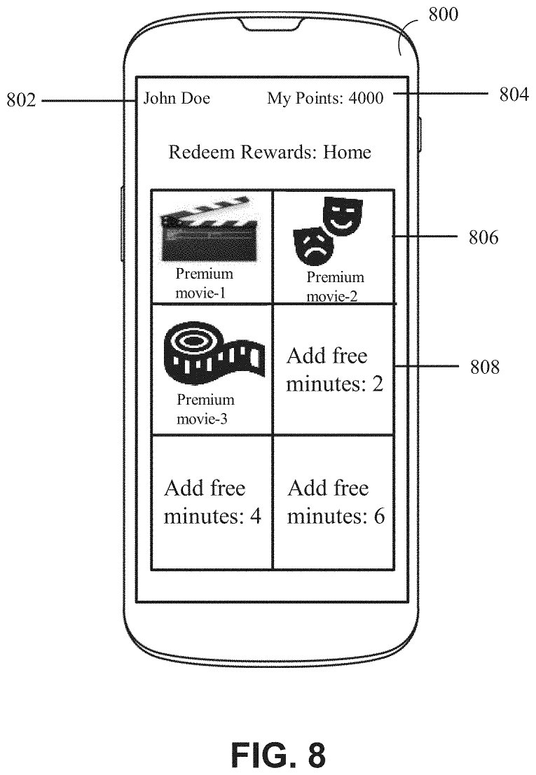

In an embodiment, the content provider server 108 is configured to display a list of rewards for which the viewer 102 may be eligible. An example user interface for displaying a list of rewards for which the viewer 102 may be eligible is described in conjunction with FIG. 8. Further, the content provider server 108 is configured to receive a reward selection by the viewer 102 and provides a reward to the viewer 102 based on the reward selection. Further, the content provider server 108 is configured to track accounting operations with the incentive available to the viewer 102. In an example, the accounting operations include checking, buying and selling the incentives available to the viewer 102.

In an example scenario, when the viewer 102 has already created an account with the content provider server 108 and received the log-in credentials. In that scenario, the content provider server 108 provides log-in option to the viewer 102 for accessing his/her profile. The viewer 102 must provide log-in credentials to access his/her profile. After login to the content provider server 108, the viewer 102 may watch content though the multimedia application. While watching the content, the viewer may actuate the web element to watch one or more advertisements. At that time, the broker server 110 obtains profile data related to the viewer 102 from the content provider server 108 and verify the viewer 102 based on the profile data. Further, the broker server 110 fetches the viewer's advertisement preferences from the profile data and provides the interactive window for displaying advertisements that are related to viewer's advertisement preferences. In an example, when the viewer 102 creates the profile in an electronic commerce site (e.g., Amazon), the interactive window displays the advertisements related to one or more products of the electronic commerce site.

FIG. 2 is a block diagram illustrating a preferred architecture 200 for the content provider to provide the incentive to the viewer 102 for watching the advertisement, according to an embodiment of the present invention. In an example, the content is a compressed, streamed movie 216, for example Titanic, and the viewer 102 accesses the content via the computing device 104. The communication device can be connected through Internet and includes software that supports streamed playback of the movie. This example is used to illustrate certain aspects of the invention but is not meant to limit the invention. For example, in an alternate embodiment, the content could be audio clips, and the communication device is a network enabled game console (such as Sony's PlayStation or Microsoft's Xbox).

In architecture 200, a content provider includes two servers (content provider server 108 and billing server 212), a broker server 110 and four databases (entertainment content database 202, advertisement content database 204, statistics database 206, and billing database 214). The two servers 108 and 110 communicate with each other and can access the relevant databases 202, 204, 206 and 214. In the example of FIG. 2, content provider server 108 accesses entertainment content database 202, whereas billing server 212 accesses billing database 214. Further, the broker server 110 accesses the advertisement content database 204, and the statistics database 206. The content provider server 108 communicates with the computing device 104 over the Internet 106 in order to establish communication between content provider and the viewer 102. The computing device 104 and content provider server 108 preferably have a client-server relationship. In an example, any of the databases may be implemented in a distributed environment of multiple servers, including the use of a peer-to-peer network where content is stored in other users' computing devices.

In an embodiment, the entertainment content database 202 stores contents preferably in a digital compressed format. The content provider server 108 identifies the required content in the entertainment content database 202 and starts content stream playback. In an embodiment, the advertisement content database 204 stores one or more advertisements preferably in a digital compressed format.

In a preferred embodiment, statistics 218 are collected about which advertisements the viewer plays. Statistical data 218 related to the viewer 102 stored in the statistics database 206 includes the user's identification code, total content and/or advertising time viewed, total incentives generated, total incentives redeemed, and number of advertisements seen. For each advertisement, a total count for advertisement played is stored as well. This information can then be used to target advertising to the viewer 102. In an embodiment, the billing database 214 stores billing information for the viewer 102. The billing information includes total amount of incentives earned and total amount of incentives redeemed for a particular time duration. This billing information is sent to the viewer 102 though an email or push notifications.

FIG. 3 illustrates an example user interface 300 for receiving the triggering event from the viewer 102, according to an embodiment of the present invention. According to one embodiment, there are one or more web elements on the user interface 300. In an example, the web elements include a profile icon 302, a search icon 304, a notification icon 306, a video icon 308, and a web button 310. The viewer 102 can click the profile icon 302 to access profile data. The viewer 102 can click the search icon 304 and enter text to search the contents which are interested to him/her. The viewer 102 can click the notification icon 306 to check if any notification has come. The viewer 102 can click the video icon 308 to upload a content. The viewer 102 can click the web button 310 to watch the advertisements. The web button 310 may provide information about the incentives earned by the viewer 102, for example, “token: 9”. In an example, instead of displaying “Tokens: 9”, the system could display ‘Ad-free hours available: 7” or “Ad viewing minutes earned: 420”.

In an embodiment, the web button 310 is associated with a counter. The counter goes up (increases) when the viewer 102 watches one or more advertisements. Similarly, the counter goes down (decreases) when the viewer 102 redeems the incentives earned for ad-free contents. Further, the user interface 300 displays content 312 and statistical data 314 related to the content 312. In an example, the statistical data includes title, number of views, and other details.

FIG. 4 illustrates an example user interface 400 of the interactive window 402 for receiving an input from the viewer 102, according to an embodiment of the present invention. In an embodiment, the interactive window 402 includes the one or more user interface elements 404, 406, 408, 410, & 412, and the section 414 for displaying an advertisement group to the viewer 102, wherein the advertisement group comprises at least one advertisement 416. In an example, the one or more user interface elements 404, 406, 408, 410, & 412 are web buttons. The viewer 102 can click the user interface elements 404 to bookmark one or more advertisements. The viewer 102 can click the user interface elements 406 to watch more advertisement similar to the displayed advertisement, for example, the advertisement 416.

Further, viewer 102 can click the user interface elements 408 to provide advertisement preferences for future advertisement display. Further, the viewer 102 can click the user interface elements 410 to exit the interactive window 402. Further, the viewer 102 can enter a text related to a type of advertisement in the user interface elements 412 to search related advertisements corresponding to the entry.

In an embodiment, the section 414 displays random advertisement to the viewer 102 if the viewer 102 has actuated the web element 310 for the first time and did not provide any preference for the advertisements. In another embodiment, the section 414 displays the advertisements which are matching the viewer's advertisement preferences if the viewer 102 has already set his/her advertisement preferences.

FIG. 5 illustrates an example user interface 500 for capturing the advertisement preferences of the viewer 102, according to an embodiment of the present invention. The user interface 500 includes toggle buttons 502 meant for setting the preferences for the advertisements. For example, the viewer 102 can set the preference as “pause” for the advertisement “312 CDM bulk batteries” by clicking the toggle button 504. These preferences will be stored in the statistics database 206. Further, these preferences allow the broker server 110 to provide relevant advertisements to the viewer 102 by comparing the one or more advertisements to the advertisement preferences and matching the advertainment preference to an advertisement.

Further, the user interface 500 allows the viewer 102 to create, edit, and delete descriptions of the ads they want to see. For example, the viewer can click “add” button 506 to create a description for a new advertisement. The new advertisement has a name, for example, hello kitty, and corresponding toggle button. The viewer 102 also can delete a preference by clicking the “delete” button 508. Further, the viewer 102 can exit the user interface 500 by clicking the “exit” button 510.

FIG. 6 illustrates an example user interface 600 for displaying the selected advertisement to the viewer 102, according to an embodiment of the present invention. When the viewer 102 clicks the advertainment 416 displayed on the section 414 of the user interface 400, the user interface 600 displays the selected advertisement 416 to the viewer 102 in the section 602. The section 602 includes a media control buttons section 604, a graphics display section 606, an advertisement details section 608. The advertisement details section 608 provides a hyperlink that connects to an advertiser. In an example, the media control buttons section 604 includes different media control buttons (such as play, pause, forward, backward, next, previous) that are used to control the displayed graphics in the graphics display section 606. For example, if a video advertisement is played for Kawasaki H2R in the graphics display section 606, the viewer 102 can play and pause the video by clicking the corresponding media control buttons.

Further, the user interface 600 includes one or more user interface elements 610, 612, 614, & 616. The viewer 102 can click the user interface elements 610 to save the advertainment displayed on the graphics display section 606. Further, the viewer 102 can click the user interface elements 612 to watch more advertisement similar to the displayed advertisement. Further, the viewer 102 can click the user interface elements 614 to provide advertisement preferences for future advertisement display. Further, the viewer 102 can click the user interface elements 616 to exit the user interface 600. In addition, the viewer 102 can remove the displayed advertisement by clicking the user interface elements 618. Further, the viewer 102 can rate the advertainment by clicking the user interface elements 620.

FIG. 7 illustrates an example user interface 700 for presenting one or more advertisement related to the entry into the input text box displayed in FIG. 4. For example, if the viewer 102 enter “skydiving” in the user interface element 412 to search related advertisements, the user interface 700 displays one or more advertisements corresponding to skydiving in the section 702. Further, the user interface 700 includes one or more user interface elements 704, 706, 708, & 710. The viewer 102 can click the user interface element 704 to save the advertainment displayed in the section 702. Further, the viewer 102 can click the user interface element 706 to watch more advertisement like the displayed advertisement. Further, the viewer 102 can click the user interface element 708 to provide advertisement preferences for future advertisement display. Further, the viewer 102 can click the user interface element 710 to exit the user interface 700. In addition, the user interface 700 allows the viewer 102 to add skydiving as advertisement preference.

FIG. 8 illustrates an example user interface 800 for displaying a list of rewards 806 & 808 for which the viewer 102 may be eligible, according to an embodiment of the present invention. In an example, the user interface 800 displays name 802 of the viewer 102 and the incentive value, for example, loyalty points. In an embodiment, the tokens could be eliminated and instead, the system could simply equate minutes-of-ads-viewed to hours of-ad-free-video-earned. The viewer 102 can chose any reward, for example, premium movie 2, to redeem the loyalty points. The reward “premium movie 2” allows the viewer 102 to watch ad-free premium content. If the viewer 102 clicks the reward 808, an example user interface 900 for redeeming the loyalty points will be opened.

FIG. 9 illustrates an example user interface 900 for redeeming the incentive for the reward, for example, reward 808, according to an embodiment of the present invention. The user interface 900 displays data (for example, reward name, how many points required to redeem for this reward, description of the reward) related to the reward in the section 902. Further, the user interface 900 includes a redeem button 904, when clicked by the viewer 102, facilitates redemption of the loyalty points.

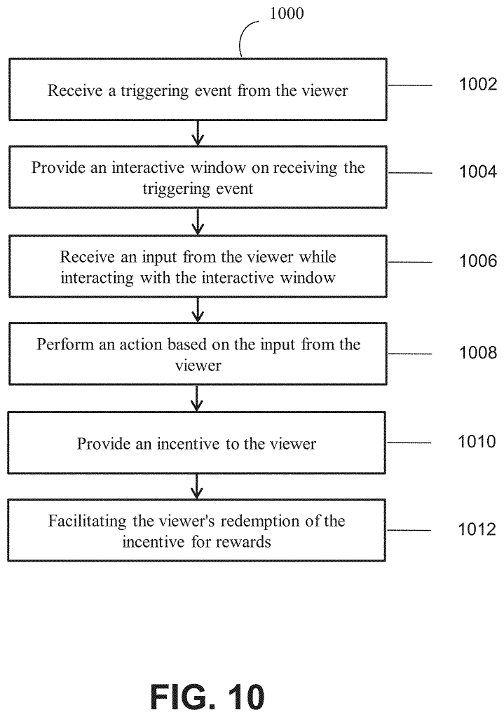

FIG. 10 illustrates a flow diagram 1000 of a method for providing the incentive to the viewer 102 for watching the advertisement, according to an exemplary embodiment of the present invention. At step 1002, the method includes receiving the triggering event from the viewer 102. In an embodiment, the triggering event occurs when the viewer 102 actuates the web element 310. The method allows the content provider server 108 to receive the triggering event from the viewer 102. At step 1004, the method includes providing the interactive window 402 on receiving the triggering event. In an embodiment, the interactive window 402 includes one or more user interface elements 404, 406, 408, 410, & 412, and the section 414 for displaying the advertisement group to the viewer 102, wherein the advertisement group includes at least one advertisement 416. The method allows the content provider server 108 to provide the interactive window 402 on receiving the triggering event.

At step 1006, the method includes receiving the input from the viewer 102 while interacting with the interactive window 402. In an embodiment, the input includes at least one of selecting one or more advertisement from the advertisement group, clicking the user interface element 408 from the one or more user interface elements 404, 406, 408, 410, & 412, and entering preference for the advertisement in the input text box 412 of the one or more user interface elements 404, 406, 408, 410, & 412. The method allows the content provider server 108 to receive the input from the viewer 102 while interacting with the interactive window 402.

At step 1008, the method includes performing one or more actions based on the type of input from the viewer 102. In an embodiment, the action includes presenting the selected advertisement 416 to the viewer 102 if the input is selecting at least one advertisement 416 from the advertisement group. In another embodiment, the action includes capturing the advertisement preferences of the viewer 102 through the user interface 500 if the input is clicking the user interface element 408 related to the advertisement preferences from the one or more user interface elements 404, 406, 408, 410, & 412. In yet another embodiment, the action includes presenting the one or more advertisement related to the entry into the input text box 412 if the input is entering preference for the advertisement in the input text box 412 of the one or more user interface elements 404, 406, 408, 410, & 412. The method allows the broker server 110 to perform the one or more actions based on the type of input from the viewer 102.

At step 1010, the method includes providing the incentive to the viewer 102. In an embodiment, value of the incentive prorated according to an amount of time the selected one or more advertisements watched by the viewer 102. The method allows the content provider server 108 to provide the incentive to the viewer 102. At step 1012, the method includes facilitating the viewer's redemption of the incentive for the rewards 806 & 808. The method allows the content provider server 108 to facilitates redemption of the incentive for the rewards 806 & 808.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

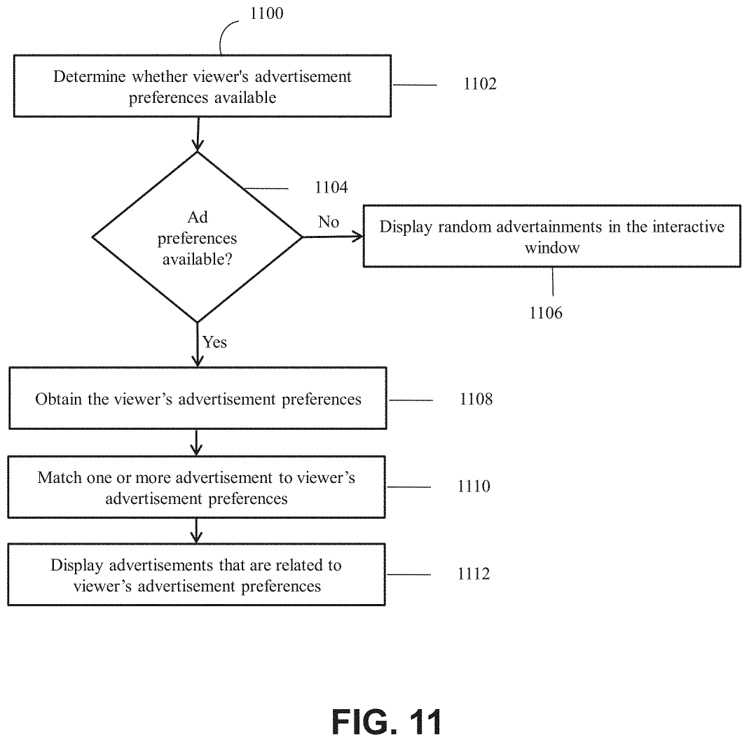

FIG. 11 illustrates a flow diagram 1100 of a method for displaying the one or more advertisements in the interactive window 402 on receiving the triggering event, according to an exemplary embodiment of the present invention. At step 1102, the method includes determining whether the viewer's advertisement preferences are stored in the content provider server 108. The method allows the broker server 110 to determining whether the viewer's advertisement preferences are stored in the content provider server 108. If it is determined, at step 1104, that the viewer's advertisement preferences are not stored in the content provider server 108, then at step 1106, the method includes displaying random or default advertisements in the interactive window 402. The method allows the broker server 110 to display random or default advertisements in the interactive window 402.

If it is determined, at step 1104, that the viewer's advertisement preferences are stored in the content provider server 108, then at step 1108, the method includes obtaining the viewer's advertisement preferences. The method allows the broker server 110 to obtain the viewer's advertisement preferences. At step 1110, the method includes matching the one or more advertisement to the viewer's advertisement preferences. The method allows the broker server 110 to match the one or more advertisement to the viewer's advertisement preferences. At step 1112, the method includes displaying the advertisements that are related to the viewer's advertisement preferences in the interactive window 402. The method allows the broker server 110 to displaying the advertisements that are related to the viewer's advertisement preferences in the interactive window 402.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

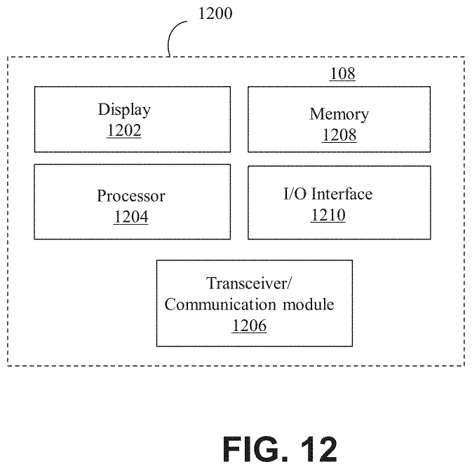

FIG. 12 illustrates a system 1200 for providing the incentive to the viewer 102 for watching the one or more advertisement, according to an exemplary embodiment of the present invention. In accordance with an example implementation, as shown in FIG. 12, the system 1200 may include at least a processor 1204, a memory 1208, a transceiver or communication module 1206, one or more I/O interfaces, such as an I/O interface 1210, and a display 1202.

The processor 1204 may be communicably coupled with the transceiver/communication module 1206 to receive data related to the viewer 102, and the triggering event from the viewer 102. Further, the transceiver 1206 may be configured to transmit data related to the incentives earned and the rewards by the processor 1204. The processor 1204 is in communication with the memory 1208, configured in the form of routines, programs, objects, components, data structures and the like, which perform particular tasks to be executed by the processor 1208. The system 1200 may be connected to other information processing devices by using the I/O interface 1210. The display 1202 may be utilized to display one or more user interfaces as disclosed above. The I/O interfaces 1210 may include a variety of software and hardware interfaces, for instance, interface for peripheral device(s) such as a keyboard, a mouse, a scanner, an external memory, a printer and the like.

In an embodiment, the processor 1204 may include different types of processors known in the art including neural network-based algorithms that are effectively used in several applications.

The proposed invention provides many advantages over the existing methods and systems. The proposes system provides an improved internet advertising model that eliminates pop-up ads and off-target ads while increasing ad click-through rates. People choose which ads they see, when to watch them, earn tokens for watching ads, and exchange the tokens for ad-free YouTube and ad-free web browsing. The proposed system allows the users to keep a list of items they want to buy and the types of ads they want to see. Users can view the ads at their convenience, and they can earn a token for each minute they view the ads. The system allows the consumers to watch ads when they want and where they want, with no uncontrolled pop-up ads. This is accomplished by issuing consumers a token for each minute they watch advertisements. Each token is worth, for example, one hour of ad-free YouTube viewing, or an hour of viewing ad-free web pages.

In conventional methods and systems, personal data and behavioral patterns of the user are analyzed to serve advertisements. The proposed system eliminates the process of going through the person's personal information, emails, searches, etc., to guess what ads to serve them. The advertiser can serve up qualified ads to consumers, without knowing anything about them, other than their list of things they want to buy. This avoids data breaching. The proposed system allows people to enjoy the content uninterrupted. Unannoyed, uninterrupted users only watch ads they want to see, when they want to see them and can exit out any time. The proposed system helps the advertisers to get increased clicks per ad displayed. The proposed system allows the advertiser to get additional insight into consumers from which ads they choose off the splash screens, which companies they connect with, etc. The proposed system can also be used by cable TV providers, Bing, etc.

Although particular embodiments of the invention have been described in detail for purposes of illustration, various modifications and enhancements may be made without departing from the spirit and scope of the invention.

What is claimed is:

1. A method for providing an incentive to a viewer for watching an advertisement, comprising:
receiving a triggering event from the viewer, wherein the triggering event occurs when the viewer actuates a web element;
providing an interactive window on receiving the triggering event, wherein the interactive window comprises one or more user interface elements, and a section for displaying an advertisement group to the viewer, wherein the advertisement group comprises at least one advertisement;
receiving an input from the viewer while interacting with the interactive window, wherein the input comprises at least one of selecting one or more advertisements from the advertisement group, clicking a user interface element from the one or more user interface elements, and entering preference for the advertisement in an input text box of the one or more user interface elements;
performing an action based on the input from the viewer, wherein the action comprising:
presenting the selected advertisement to the viewer if the input is selecting at least one advertisement from the advertisement group,
capturing advertisement preferences of the viewer through a user interface if the input is clicking a user interface element related to advertisement preferences from the one or more user interface elements, and
presenting the one or more advertisement related to the entry into the input text box if the input is entering preference for the advertisement in the input text box of the one or more user interface elements;
providing an incentive to the viewer, wherein value of incentive prorated according to an amount of time the selected one or more advertisements watched by the viewer; and
facilitating the viewer's redemption of the incentive for rewards.

2. The method of claim 1, further comprising storing advertisement preferences of the viewer.

3. The method of claim 1, wherein means for actuating the web element comprises one of touching, clicking, and tapping.

4. The method of claim 3, wherein the web element comprises one of a widget, a click button, a graphical control element, and a graphical user interface element.

5. The method of claim 1, wherein the user interface elements comprise one of checkboxes, radio buttons, dropdown lists, list boxes, buttons, toggles, text fields, date field, icons, carousels, and search fields.

6. The method of claim 1, wherein the interactive window comprises one of a dynamic flyer, a card and a modal.

7. The method of claim 1, displaying one or more advertisements in the interactive window on receiving the triggering event further comprising:
determining whether the viewer's advertisement preferences are available;
displaying random or default advertisements in the interactive window if it is determined that the viewer's advertisement preferences are not available;
obtaining the viewer's advertisement preferences if it is determined that the viewer's advertisement preferences are available;
matching the one or more advertisement to the viewer's advertisement preferences; and
displaying the advertisements, related to the viewer's advertisement preferences, in the interactive window.

8. The method of claim 1, the input further comprises at least one of bookmarking one or more advertisements, fetching similar advertisements corresponding to the advertisement group, and exiting the interactive window.

9. The method of claim 1, wherein the incentive comprises at least one of a loyalty point, a virtual coin, and a value token.

10. The method of claim 1, wherein the reward is selected from the group consisting of advertisement free time-duration for watching content, advertisement free time-duration for browsing, advertisement free premium content, and the like.

11. The method of claim 1, further comprising:
displaying a list of rewards for which the viewer may be eligible;
receiving a reward selection by the viewer; and
providing a reward to the viewer based on the reward selection.

12. The method of claim 1, further comprising allowing the viewer to perform accounting operations with the incentive available to the viewer, wherein accounting operations comprises checking, buying and selling the incentives available to the viewer.

13. A system for providing an incentive to a viewer for watching an advertisement, comprising:
a memory;
a processor, coupled to the memory, configured to:
receive a triggering event from the viewer, wherein the triggering event occurs when the viewer actuates a web element;
provide an interactive window on receiving the triggering event, wherein the interactive window comprises one or more user interface elements, and a section for displaying an advertisement group to the viewer, wherein the advertisement group comprises at least one advertisement;
receive an input from the viewer while interacting with the interactive window, wherein the input comprises at least one of selecting one or more advertisement from the advertisement group, clicking a user interface element from the one or more user interface elements, and entering preference for the advertisement in an input text box of the one or more user interface elements;
perform an action based on the input from the viewer, wherein the action comprising:
present the selected advertisement to the viewer if the input is selecting at least one advertisement from the advertisement group,
capture advertisement preferences of the viewer through a user interface if the input is clicking a user interface element related to advertisement preferences from the one or more user interface elements, and
present the one or more advertisement related to the entry into the input text box if the input is entering preference for the advertisement in the input text box of the one or more user interface elements;
provide an incentive to the viewer, wherein value of incentive prorated according to an amount of time the selected one or more advertisements watched by the viewer; and
facilitate the viewer's redemption of the incentive for rewards.

14. The system of claim 13, wherein the processor configured to display one or more advertisements in the interactive window on receiving the triggering event further comprising:
determining whether the viewer's advertisement preferences are available;
displaying random or default advertisements in the interactive window if it is determined that the viewer's advertisement preferences are not available;
obtaining the viewer's advertisement preferences if it is determined that the viewer's advertisement preferences are available;
matching the one or more advertisement to the viewer's advertisement preferences; and
displaying the advertisements, related to the viewer's advertisement preferences, in the interactive window.

15. The system of claim 13, wherein the processor further configured to:
display a list of rewards for which the viewer may be eligible;
receive a reward selection by the viewer; and
provide a reward to the viewer based on the reward selection.

16. The system of claim 13, wherein the processor further configured to:
allow the viewer to perform accounting operations with the incentive available to the viewer, wherein accounting operations include checking, buying and selling the incentives available to the viewer.
